(19) United States
(12) Patent Application Publication
(10) Pub. No.: US 2001/0011020 A1
(43) Pub. Date: Aug. 2, 2001

(54) Method for transferring and reflecting message by using short message service (SMS) in a portable digital phone

(75) Inventor: Seung-Hyun Nahm, Songnam-shi (KR)

Correspondence Address: KLAUBER & JACKSON, 411 HACKENSACK AVENUE, HACKENSACK, NJ, 07601

(73) Assignee: SAMSUNG ELECTRONIC CO., LTD.

(21) Appl. No.: 09/769,996

(22) Filed: Jan. 25, 2001

(30) Foreign Application Priority Data
Jan. 28, 2000 (KR) P2000-4219

(51) Int. Cl. H04Q 7/20

(52) U.S. Cl. 455/466; 455/414

(57) ABSTRACT

Disclosed is a method for operating an SMS in a portable digital phone, more particularly a method for transferring and responding to a message using an SMS in a portable digital phone. The method according to the present invention includes the steps of drafting a message with a plurality of optional messages by a sending party; transferring the optional messages as an SMS message during a transferring mode; and receiving and responding to the sender's message by selectively responding to the optional messages.

### CLAIM OF PRIORITY

This application claims priority to an application entitled, “Method for Transferring and Reflecting Message by Using SMS in Portable Digital Phone”, filed with the Korean Industrial Property Office on Jan. 28, 2000 and there duly assigned Serial No. 99-9510.

### BACKGROUND OF THE INVENTION

1. Field of the Invention

The present invention relates to a method for operating a short message service (SMS) in a portable digital phone, more particularly to a method for transferring an SMS message and responding to the SMS message more efficiently.

2. Description of the Related Art

Short Message Services (SMS) are offered by operators of wireless communication systems. SMS messages are typically delivered by a wireless network to a digital phone. Hence, the SMS can be utilized in all three major digital standards deployed through the United States; Code Division Multiple Access (CDMA), Time Division Multiple Access (TDMA), and Global Systems for Mobile (GSM). Thus, most portable digital phones today are capable of transferring text messages entered by a user through the short message service (SMS) to another portable digital phone. Operation of the SMS is executed in the steps of drafting, editing, and transferring messages to an intended user.

FIGS. 1(a) and 1(b) illustrate conventional methods showing the operational steps of exchanging SMS messages and responding to the received SMS messages in a portable digital phone.

Referring to FIGS. 1(a) and 1(b), the mobile phone user transmitting a message determines whether or not a demand for drafting/entering a message is made in step 110. If the answer is affirmative, the demanded message is drafted in step 112. In step 114, it is determined whether or not there has been any input initiating the provision of the drafted SMS to the receiving party. If the answer is affirmative, the drafted message is transferred to the receiving party via the SMS in step 116.

In response to the transmitting message from the sending party, the following executions of confirming and responding to the transmitted message are performed by the receiving party.

With reference to FIG. 1(b), the portable phone is in an idle state in step 120. In step 122, it is determined whether or not any SMS messages have been received from the transmitting end. If the answer is affirmative, the received message(s) is/are detected and stored in a predetermined storage section in step 124. If there has been any input of a demand for confirming the stored message in step 126, the stored message is displayed on the screen of the mobile phone in step 128. In step 130, it is determined whether or not there has been any response input from the receiving party. If so, a response message is transmitted back to the transmitting party in step 132.

As described above, the conventional method comprises the transmission of an SMS message, the confirmation of the transferred message, and the provision of a response message. In this operation of the transmission and confirmation of a message, if the receiving party responds to the received message, the transmission of the response message is automatically transferred back to the phone number of the sending party without incurring a call connection charge. Frequently, the receiving party needs to re-draft some portion of the transmitted message to adequately respond to the sending party. Thus, it would be easier for the sending party to receive a more descriptive response from the receiving party to ensure that the response message addresses the earlier transmitted message. However, the receiving party must incur a connection charge if some portion of the transmitted message needs to be entered/edited and transmitted back to the sending party since a call connection needs to be established to the sending party. Moreover, it is a cumbersome process to retype or enter new responding message back to the sending party. Thus, most of the receiving parties do not opt for redrafting a message due to this type of inconvenience.

For reasons of the above limitations, there has been a growing demands for enabling the receiving party to respond to the received message that is not cumbersome and without incurring call charges for the responding party. Thus, there is a need to allow a simple and a convenient way of responding to a message sent by the sending party.

### SUMMARY OF THE INVENTION

To resolve the above problems, an object of the present invention is to provide a method for exchanging SMS messages between the sending party and the receiving party in more efficient and convenient ways.

To be specific, an object of the present invention is to provide a method for transferring and responding SMS messages in a way that enables a message sending party to receive an appropriate response to the sent message and enables a message receiving party to reflect the significant portions of the received message to fully respond in a simple manner, without undergoing complicated procedures of connecting a communication link to the sender's phone number or without drafting a whole response message.

To achieve the above object, the present invention provides a method for transferring and responding to the SMS messages which includes the steps of drafting a message with a plurality of optional messages from a sending party, transferring the optional messages as an SMS message during the transferring mode; and receiving and responding to the sender's message by selectively responding to the optional messages.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1(a) is a flow chart showing the state of transferring the SMS message of a portable digital phone according to the conventional technology;

FIG. 1(b) is a flow chart showing the sate of receiving and responding to the SMS message according to the conventional technology;

FIG. 2(a) is a flow chart showing the state of transferring an optional message through the SMS of a portable digital phone according to a preferred embodiment of the present invention;

FIG. 2(b) is a flow chart showing the state of receiving and reflecting an optional message through the SMS of a portable digital phone according to the preferred embodiment of the present invention;

FIG. 3(a) is a flow chart showing the display of the state of transferring an optional message through the SMS service of a portable digital phone according to the preferred embodiment of the present invention; and,

FIG. 3(b) is a flow chart showing the display on a screen of the state of receiving and reflecting the optional message through the SMS service of a portable digital phone according to the preferred embodiment of the present invention.

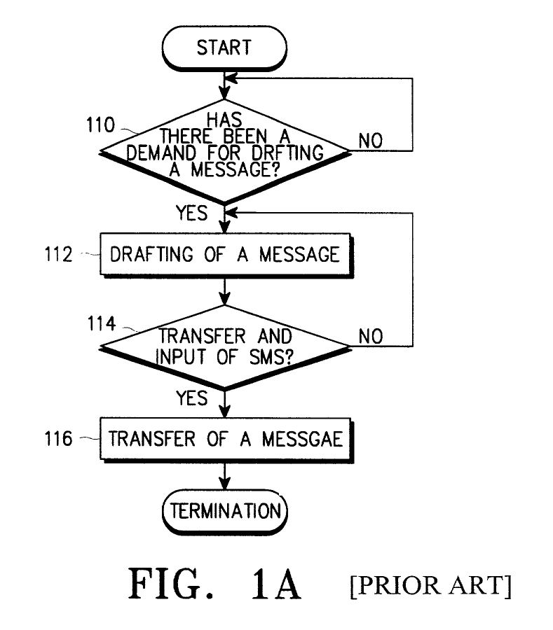

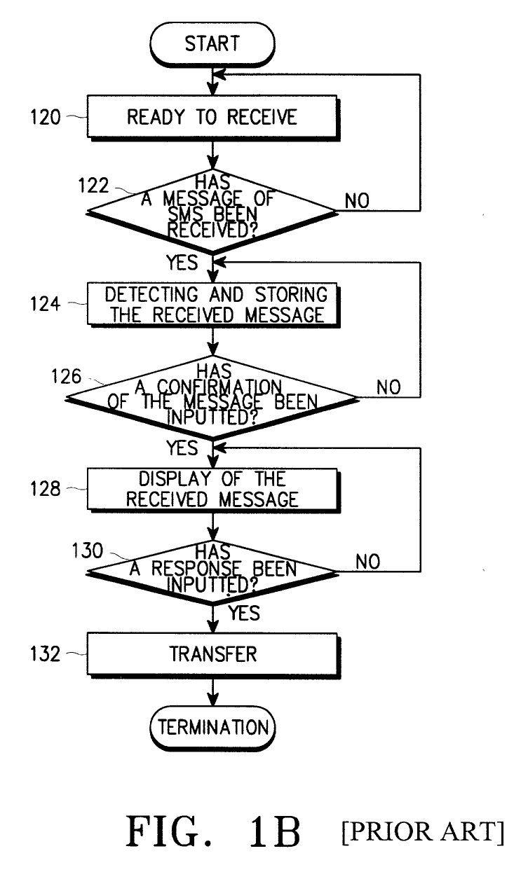

### DETAILED DESCRIPTION OF THE PREFERRED EMBODIMENT

A preferred embodiment of the present invention will be described herein below with reference to the accompanying drawings. In the drawings, the same drawing reference numerals are used to identify the same elements even if they appear in different drawings. For the purpose of clarity, well-known functions or constructions are not described in detail as they would obscure the invention in unnecessary detail. Moreover, a description of the internal structure of the portable digital phone embodying the present invention will be omitted because the structure is inferable by those skilled in the art, and it should be noted that the portable digital phone according to the present invention is equipped with the SMS function and supported by the system. Hence, the portable phone, to which the present invention is applicable, is embodied to perform a program and an equivalent thereto as described herein below.

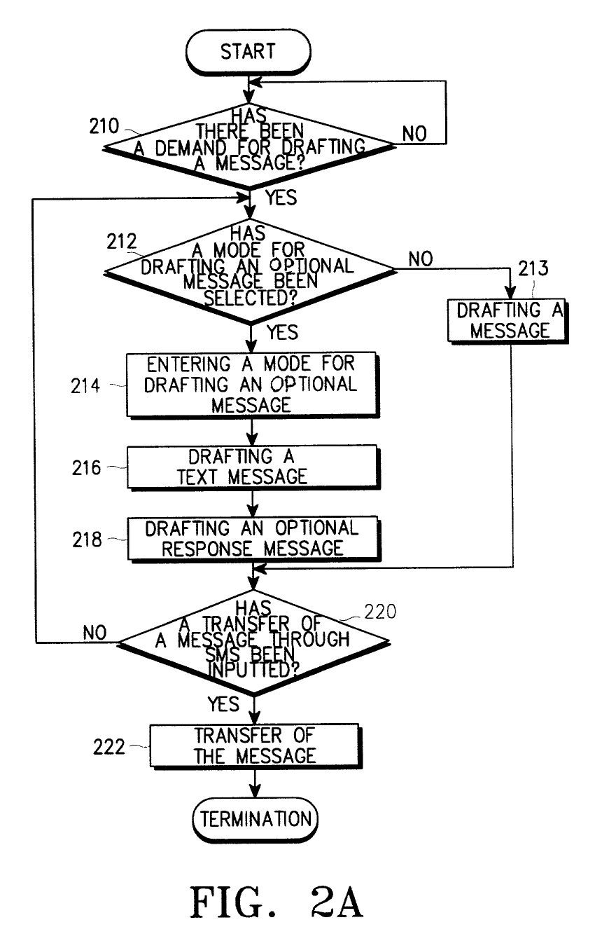

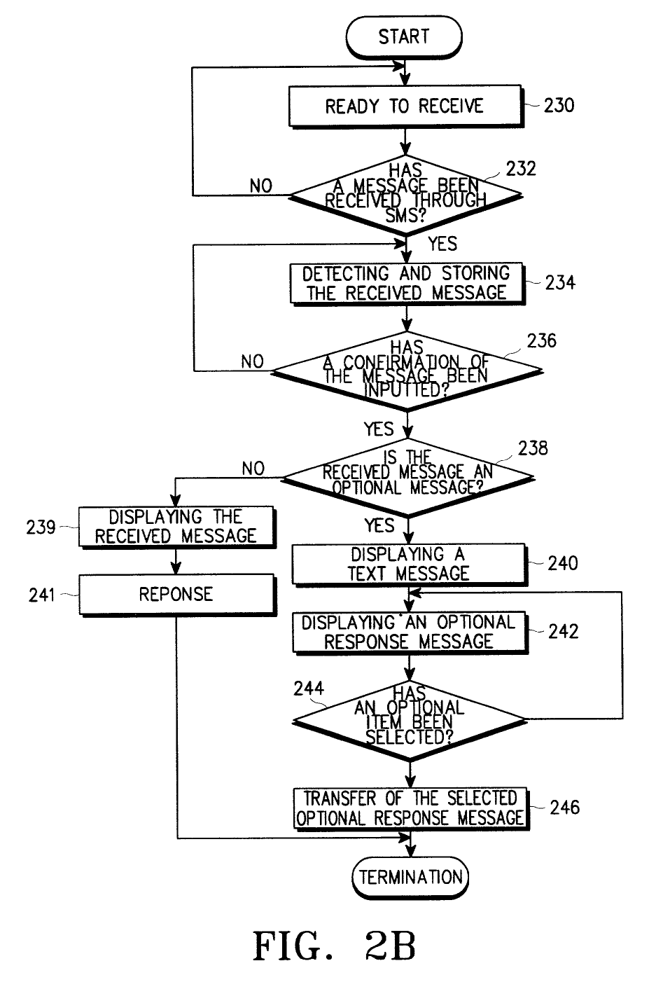

FIG. 2(a) is a flow chart showing the state of transferring an optional message through the SMS of a portable digital phone according to a preferred embodiment of the present invention. Referring to FIG. 2a, it is determined in step 210 whether or not a user has inputted any demand or request for drafting a message. If the answer is affirmative, it is determined in step 212 whether or not the user has inputted a selection to include an optional message during a drafting mode. If affirmative, an optional message drafting mode is activated in step 214. If it is determined in step 212 that the user has not inputted a selection for an optional message drafting mode but for an ordinary message drafting mode, then a message drafting mode is activated in step 213 to draft a normal message.

In step 216, a message (i.e., “Attendance to a conference requested”) is entered by a sending party using the key pad or via voice dictation. If the message insertion is completed in step 216, an optional responding message will be entered in step 218. The message drafted at this stage is a selection message to be responded by a receiving party to the text message drafted in step 216. Here, the optional message may be divided into a plurality of selection item texts, such as “1. Attending”, “2. Not Attending”, “3. Please Call-Back (i.e., 212-555-7488).” These optional messages allow the receiving party to select one of them upon receiving the message from the sending party. For example, if the item 3, “Please call back”, is selected by the receiving party, the selected option is then notified back to the sending party in the form of a response message. Item 3 then may be opted for when the receiving party desires to return a call back from the message originating party. Accordingly, the message sending party can call back the receiving party via the call-back number provided by the receiving party. In step 220, it is determined whether the receiving party opted to respond to the received message. If affirmative, the message option selected by the receiving party is transmitted back to the sending party in step 222. Finally, if the message drafting has been completed in step 213, the operation in step 220 is repeated.

FIG. 2b is a flow chart showing the state of receiving a message forwarded by a sending party and responding to an optional message through the SMS of a portable digital phone according to the preferred embodiment of the present invention. Referring to FIG. 2(b), a being-ready state is maintained in step 230. It is determined in step 232 whether or not any SMS message has been received at the receiving end. If the answer is affirmative, the received message is detected and stored in step 234. Then, it is determined in step 236 whether or not the receiving party wishes to retrieve the stored message. If the answer is affirmative, it is determined in step 238 whether or not the user has selected an option to select one of the messages with an optional message. If the answer is negative, it is determined that the receiving party has selected to a regular SMS message without the optional message. Then, the selected message is retrieved and displayed to the receiving party in step 239. A response to the received message according to the conventional method is made in step 241.

If the selection to retrieve a message with an optional message is made in step 240, the selected stored text message is retrieved and displayed. For example, a message of “Attendance to a conference requested” can be displayed, and the corresponding optional response message inputted by the sending party is displayed in step 242 (i.e., “1. Attending, “2. Not Attending”, and “3. Call-Back Number.”). Then, it is determined in step 244 whether or not the receiving party has selected one of the optional messages. If affirmative, the optional message selected in step 246 is transferred in the form of an SMS message back to the sending party, without the need to establish a communication link with the sending party.

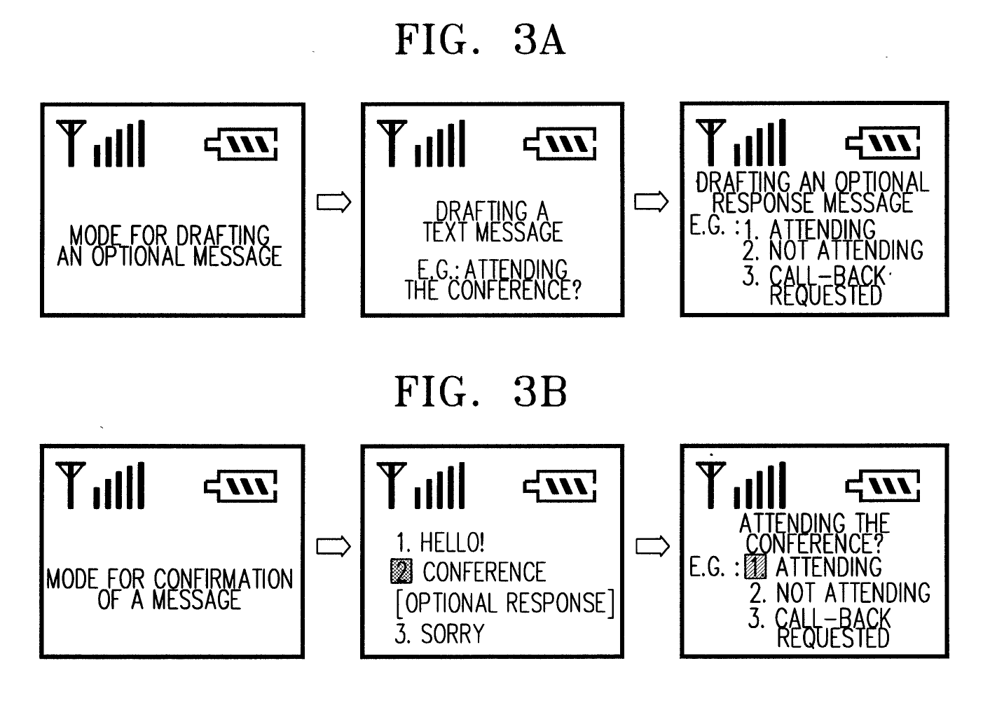

With reference to FIGS. 3(a) and 3(b), the above procedures are shown for better understanding of the present invention. FIG. 3(a) is a flow chart showing the sequence states of transferring an optional message through the SMS service in a portable digital phone of the sending party according to the preferred embodiment of the present invention. FIG. 3(b) is a flow chart showing the sequence states of receiving and responding to the optional message through the SMS service in a portable digital phone of the receiving party according to the preferred embodiment of the present invention.

As described above, the present invention has the advantage of enabling a convenient way of transferring a message and responding to the same message thereto between a sending party and a receiving party using portable digital phones.

While the invention has been shown and described with reference to a certain preferred embodiment thereof, it will be understood by those skilled in the art that various changes in form and detail may be made therein without departing from the spirit and the scope of the invention as defined by the appended claims.

What is claimed is:

1. A method for exchanging a message using a short message service (SMS) between a sending party and a receiving party, the method comprising the steps of:
creating a text message by said sending party in a first portable digital phone;
creating a plurality of optional response messages associated with said text message; and
forwarding said text message with said optional response messages to said receiving party via said SMS channel.

2. The method of claim 1, further comprising the step of, upon receiving said text message, selectively choosing one of said optional response messages by said receiving party in a second portable digital phone.

3. The method of claim 1, wherein one of said optional response messages includes a call-back number allowing a response entered by said receiving party to be transmitted back to said sending party.

4. The method of claim 1, wherein said optional response messages are stored in a memory means of said second phone for a provision to said receiving party thereafter.

5. A method for exchanging a message using a short message service (SMS) between a sending party and a receiving party, the method comprising the steps of:
detecting a message having a plurality of optional response messages stored in a portable digital phone of said receiving party;
retrieving to display said text message with said optional messages;
selecting one of said optional response messages by said receiving party;
forwarding said selected optional response message back to said sending party via said SMS channel.

6. The method of claim 5, wherein said optional response messages comprises a plurality of items identifying different messages to be selected by said receiving party.

7. The method of claim 5, wherein said optional response messages are transmitted to said receiving party by said sending party.

8. The method of claim 6, wherein said optional response messages include a call-back number allowing said selected response entered by said receiving party to be transmitted back to said sending party.

9. A method for exchanging a message using a short message service (SMS) between a sending party and a receiving party, the method comprising the steps of:
creating a text message having a plurality of optional response messages associated to said text message in a first digital terminal of said sending party;
forwarding said text message with said optional response messages to a second digital terminal of said receiving party via said SMS channel;
selecting one of said optional response messages by said receiving party; and
forwarding said selected optional response message back to said sending party via said SMS channel.

10. The method of claim 9, further comprising the step of storing said text message and said optional response messages in said second terminal upon receiving said text message from said sending party via said SMS channel.

11. The method of claim 10, further comprising the step of retrieving said text message and said optional messages for a provision to said receiving party.

12. The method of claim 11, further comprising the step of displaying said retrieved messages in a display unit of said second digital terminal.

13. The method of claim 9, wherein said optional response messages include a call-back number allowing said selected response entered by said receiving party to be transmitted back to said sending party.
